(19) United States
(12) Patent Application Publication
(10) Pub. No.: US 2004/0206221 A1
(43) Pub. Date: Oct. 21, 2004

(54) Device for cutting pieces of wood to size

(76) Inventor: Franz Loffler, Illertissen (DE)

Correspondence Address: M. Robert Kestenbaum, 11011 Bermuda Dunes NE, Albuquerque, NM, 87111, US

(21) Appl. No.: 10/824,918

(22) Filed: Apr. 15, 2004

(30) Foreign Application Priority Data
Apr. 16, 2003 (DE) 103 17 864.3

(51) Int. Cl. B26D 7/01

(52) U.S. Cl. 83/574; 83/452

(57) ABSTRACT

A device for cutting pieces of wood to size, in particular meter-long logs, to form log pieces or firewood, has a frame for accommodating meter-long items. The frame comprises spaced-apart holding elements that are designed in a U shape and between which free regions for saw cuts are provided. It is possible for the frame to be shifted from a sawing position about a pivot axis into an unloading position.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON COMPACT DISC

Not applicable.

### BACKGROUND OF THE INVENTION

1. Field of the Invention

The invention relates to a device for cutting pieces of wood to size.

2. Description of the Related Art Including Information Disclosed Under 37 CFR 1.97 AND 1.98

French Patent Document 27 01 663 discloses a sawing device in which a bundle of meter-long logs are accommodated in a bundled form on a mobile chassis by a clamping device. These bundled meter-long items hang in a loop structure on the framework. Saw cuts can be set between the individual loops of U-shaped design and at the clamping device, which holds the meter-long logs in a bundled form. The height of the frame and the height of the loop structure are selected in such a way that a wheelbarrow is positioned below the cut-to-size bundle, which is unloaded onto the wheelbarrow. After that, the wheelbarrow can take the bundled and cut wood away.

This device has the disadvantage that the insertion of the meter-long items into the loop structure requires considerable exertion on account of the height. In addition, the reloading after the cutting from the loop structure into the wheelbarrow is problematical, since the other bundles arranged in the loop structure are freely movable back and forth and, if a bundle swings back, there is the risk of the bundle to be unloaded not falling into the wheelbarrow positioned underneath. In addition, the chassis for accommodating the meter-long items protrudes to a considerable extent and is unstable and requires considerable storage space.

### BRIEF SUMMARY OF THE INVENTION

The object of the present invention is therefore to provide a device for cutting pieces of wood to size, in particular meter-long logs, to form log pieces or firewood. The device according to the present invention permits simple loading and unloading, is a simple design, permits safe transport of stacked wood, and is easy to bring to any site.

This object is achieved according to the invention by a device for cutting pieces of wood to size having the following features: A device for cutting pieces of wood to size, in particular metre-long logs, to form log pieces or firewood, having frame (12) for accommodating metre-long items, which frame (12) comprises spaced-apart holding elements (16) which are designed in a U-shape and between which free regions (46) for saw cuts (43) are provided, characterized in that the frame (12) can be shifted from a sawing position (40) about a pivot axis (24) into an unloading position (54).

The device according to the present invention, which is used to cut pieces of wood to size, in particular meter-long logs, to form log pieces or firewood that preferably have a length of about 33 cm, has the advantage that simple loading with meter-long wood items is made possible, the setting of a saw cut is ensured and effected in a simple manner and provides for simple unloading of the cut-to-size bundles by the pivoting movement of the device from a sawing position into an unloading position. This device is kept simple in construction, providing for safety during the cutting-to-size of the meter-long logs and also in the arrangement of the device in the sawing position and unloading position. In addition, this device can be manipulated in a very simple manner and without a large expenditure of force, making fatigue-free work possible.

According to an advantageous configuration of the invention, provision is made for at least one leg of the U-shaped holding element to be designed as a supporting surface in an unloading position of the device. The frame or at least one leg of the U-shaped holding element, in particular the vertical section, therefore, has a double function. In the loading position, this leg serves to stack the meter-long items. In the unloading position, a reliable supporting surface provides for the removal of the cut bundles.

The pivot axis of the frame for accommodating the meter-long items is preferably provided in a chassis. This pivot axis can be parallel to the pivot axis of the travel rollers of a chassis or at right angles thereto. An especially simple configuration with a compact type of construction is provided for if the pivot axis is preferably provided parallel to the pivot axis of the travel rollers or in the bearing spindle of the travel rollers on a chassis.

According to a preferred embodiment of the invention, provision is made for a pivot radius of the frame to be arranged in a sunken position relative to a wheel axle of a chassis. This provides for a safe parking position of the device during loading and unloading. In addition, the existing levers provide for pivoting of the device from the sawing position into the unloading position.

The roughly U-shaped frame, between an essentially vertical section and a horizontal section, has an inclined section that, during a pivoting movement of the frame from the sawing position into an unloading position, first of all comes to bear with the ground. This permits controlled pivoting in two stages, as a result of which provision is made for reliable manipulation of the device. In addition, the arrangement of the device, not yet loaded, in this intermediate position between the sawing position and the unloading position can allow facilitated loading, the shifting into the sawing position being possible in a simple manner after the loading of the device. This inclined section may be of rectilinear design. When tubes, in particular, are used for the holding elements, these holding elements can be bent in a radius in a U shape or can be folded and/or bent approximately in a U shape. The individual functions, such as loading position, intermediate position and unloading position, can likewise be determined by the size of the bending radius between the two vertical sections. The bending radius between the two vertical sections may vary and may be designed to be discontinuous or continuous or with rectilinear sections arranged in between. Adaptation to the size and the accommodation volume of the holding elements may be provided when selecting the bending radius or bending radii or the curved shape.

During a further pivoting movement from the intermediate position into an unloading position, provision is advantageously made for the travel rollers of the chassis to be lifted from the ground. As a result, the device rests safely on the ground, so that the cut-to-size bundles can be unloaded in a simple manner. Slipping out of the way on account of at least partial contact of the travel rollers with the ground cannot occur.

So that the travel rollers in the unloading position are lifted from the ground, provision is advantageously made for the horizontal section and the inclined section or the transition section to be matched to one another in length, so that, when the device is arranged in an unloading position, lifting of at least one travel roller is ensured. At the same time, this arrangement enables wood, which is accommodated in the frame and is tied into a bundle to form a roughly round bundle, which is advantageous for stacking and transporting.

According to a further advantageous configuration of the invention, provision is made for three U-shaped holding elements to be provided on a bottom bearer, and for the top free ends of the holding elements to be fixed relative to one another by preferably at least one tie rod. This can serve to stiffen the frame. The wood to be cut is usually provided as meter-long items. The firewood itself is normally cut to a length of about 33 cm. The holding elements are preferably spaced apart on the bearer at a distance of about 33 cm, so that a saw cut can always be set in the centre region between two bearers. This embodiment is only exemplary. The holding elements may also be positioned at an asymmetrical distance from one another. A plurality of holding elements may likewise be provided on a bearer if longer pieces of wood are to be processed.

Provision is advantageously made for the tie rod to be provided between the holding elements so as to be pivotable or removable relative to the holding elements. As a result, the accessibility to the intermediate spaces between the holding elements can be increased.

As viewed in cross section, the holding elements for the frame are preferably of U-shaped or C-shaped design. As a result, conventional profiles (which have high stiffness) can be used in order to permit robust use. At the same time, this cross-sectional shape has the advantage that a clamping device with which the meter-long items to be cut are fixed to form a bundle can be inserted before the meter-long items are inserted into the frame. Furthermore, this arrangement has the advantage that the inserted clamping devices do not disturb the loading operation. Alternatively, provision may be made for the clamping devices to merely rest on the bearer and for them to be placed around the meter-long items after the latter have been loaded.

The holding elements can also preferably have a closed profile, which can have round or polygonal or also other profile shapes.

Provision is preferably made for clamping straps to be designed as the clamping device, these clamping straps being inserted on or inside the holding elements and bearing against the top free end, or being fixed thereto as an aid, during the loading of the device. After that, simple bundling and fixing of the meter-long items can be provided by the clamping straps, which preferably have a quick-release lock and an auxiliary clamping device.

The device is advantageously connected together by releasable push-in or catch connections. For example, the U-shaped holding elements can be arranged on the bearer or on the pivot axis in a push-in manner. Likewise, the individual sections of the holding elements can be capable of being pushed in relative to one another.

Provision is likewise made for the travel rollers or the chassis to be provided in a push-in manner relative to the frame or the pivot axis. This makes it possible for the components to be capable of being exchanged individually. Furthermore, dismantling may be effected simply and quickly for the transport of the device, so that a compact packing size is provided for. This is likewise advantageous for the delivery or distribution of the device for the customer.

According to a further advantageous configuration of the invention, provision is made for a support or a supporting roller to be provided on a holding element, preferably in the centre region. This provides for three-point support of the frame, thus providing for a safe arrangement in the position for loading and also in the sawing position.

A handle or a shaft is advantageously provided in a push-in manner on the holding element, preferably on the center holding element. This facilitates the manipulation and the pivoting movement of the device. At the same time, a lever effect can thus be achieved, as a result of which the use of force for the operation and manipulation of the device during the pivoting into the sawing position, intermediate position or unloading position can be reduced.

The common pivot point of the meter-long logs, which are accommodated by the holding elements in the frame, advantageously lies outside the pivot axis of the frame. As a result, the parking position during the sawing and during the loading of the device can be improved. This is advantageous during the loading of an empty device, so that, if attention lapses slightly, the loading position of the device is retained automatically. In particular, the pivot axis of the frame is provided in a sunken position relative to the wheel axle. The tilting moment is reduced as a result. The larger the offset is, the more stable the position of the frame becomes, for example during the loading of the device.

According to a further advantageous configuration of the invention, provision is made for a wooden or plastic strip or a sleeve to be provided as a saw guard on the bearer for accommodating the U-shaped holding elements. This can ensure that, on the one hand, a complete saw cut of the bundled and stacked meter-long items is effected and that, on the other hand, protection of the saw blade is provided for.

Furthermore, provision may advantageously be made for guide elements to be capable of being inserted or to be arranged between the U-shaped holding elements, which guide elements guide a saw cut and at the same time can form a splash guard for wood possibly splitting off.

According to an advantageous configuration of the invention, provision is made for the holding elements on a front side to have a vertical section, which is shorter than the rear vertical section. This can provide for facilitated loading and unloading. Furthermore, this configuration can serve as a limit of the filling height in order to avoid overloading.

As an alternative to the limit of the filling height, markings, which are arranged in a displaceable manner on the holding elements, may also be provided.

A hand-guided power saw is preferably used for cutting meter-long items into individual pieces of wood. Such power saws may be both chain saws and crosscut saws. A quick and neat saw cut could thus be set.

### BRIEF DESCRIPTION OF THE SEVERAL VIEWS OF THE DRAWING(S)

The invention and further advantageous embodiments and developments of the same are described and explained in more detail below with reference to the example shown in the drawing. The features, which can be gathered from the description and the drawing, may be used individually on their own or several of them may be used in any desired combination according to the invention.

In the drawing:

FIGS. 1a/b show a perspective front and rear view of the device according to the invention,

FIG. 2 shows a schematic side view along section line II-II in FIG. 1a,

FIG. 3 shows a perspective view of a loaded device in a sawing position,

FIG. 4 shows a perspective representation of the device according to the invention, without meter-long items, in an intermediate position,

FIG. 5 shows a perspective representation of the device according to the invention in an unloading position,

FIG. 6 shows a perspective representation of the device according to the invention in an unloading position, the device being partly unloaded,

FIG. 7 shows a schematic partial view of an alternative device according to the invention,

FIGS. 8a/b show a perspective view of a guide element for accommodating a sawing device,

FIGS. 9a-d show schematic representations of a further embodiment of a guide element for sawing devices.

### DETAILED DESCRIPTION OF THE INVENTION

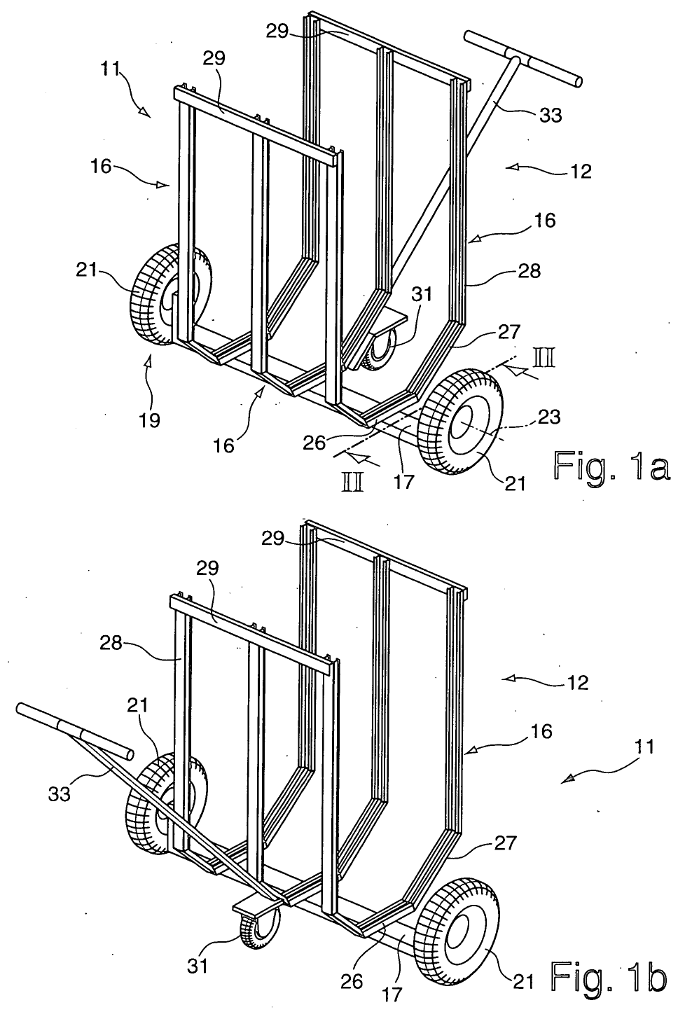

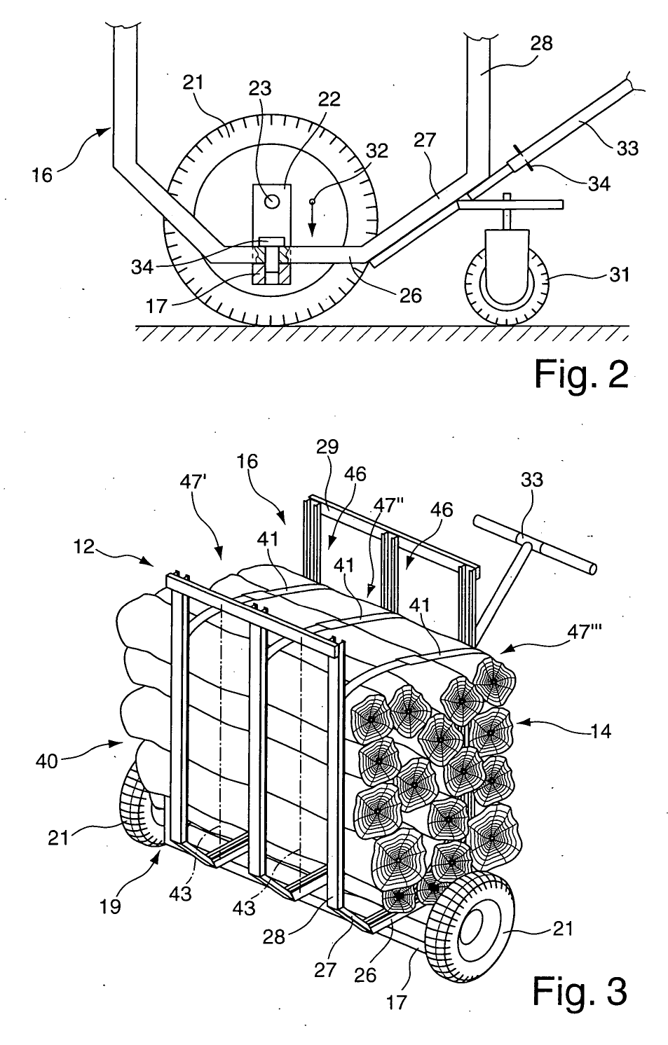

A device 11 for cutting pieces of wood to size, in particular meter-long logs, to form log pieces or firewood, is shown in a perspective front view and a perspective rear view in FIGS. 1a and b. FIG. 2 shows a schematic partial section along line II-II in FIG. 1a. The device 11 has a frame 12 for accommodating meter-long logs 14. This frame 12 comprises roughly U-shaped holding elements 16 which are arranged on a bearer 17. The bearer 17 at the same time forms part of a chassis 19, which in each case has a travel roller 21 at the left-hand and right-hand ends of the bearer 17. The bearer 17 is arranged in a sunken position relative to a wheel axle 23 of the travel rollers 21 via lugs 22. As a result, the frame 12 is arranged in a pivotable manner relative to the wheel axle 23 along a pivot radius 24 and in a sunk position, a lower centre of gravity of the frame 12 for accommodating the meter-long logs 14 thereby being provided for at the same time.

In a first embodiment, the bearer 17 is designed as a tube of preferably rectangular cross section. Further cross-sections, such as round or polygonal, preferably hexagonal, or the like and also open profiles may likewise be provided. The holding elements 16 are fastened to this bearer 17. The holding elements 16 consist of U- or C-shaped profiles and have a horizontal section 26, an inclined section 27 and a vertical section 28. The holding elements 16 are, for example, equi-spaced and are preferably at a distance apart of about 33 cm. Further positions on the bearer 17 are possible. The holding elements 16 may also be formed from a bent tube or tube sections. The holding elements 16 may likewise comprise further profile shapes, such as T-shaped profiles for example.

A tie rod or strut 29 is provided at the top free end of the holding elements 16. This tie rod or strut 29 may be provided in a fixed position on the top end of the vertical sections 28 or may be arranged in a pivotable manner in the centre holding element 16. Two tie rods 29 may likewise be provided on each side of the holding elements 16 in order to be pivotable separately from one another in each case and in order to open the intermediate space at the top between the holding elements 16.

A supporting roller 31 is shown on a center holding element 16, preferably on the inclined section 27. This arrangement and also the asymmetrical arrangement of the frame 12 relative to the bearer 17 provide for a safe parking position for loading in a sawing position of the device 11. It can be seen in particular from FIG. 2 that the wheel axle 23 and deflection are provided asymmetrically to the centre of gravity 32 and this positioning is provided by an at least slight offset in the positioning of the horizontal section 26 relative to the bearer 17. This arrangement has the advantage that the parts can otherwise be of symmetrical design, thus providing for a simple configuration in production. At the same time, assembly is facilitated, in particular in a detachable and push-in configuration, and it is ensured that the device is correctly fitted together.

A manipulating shaft 33 is preferably provided on the centre holding element 16. This shaft 33 is arranged in such a way that it can be pushed in and can be fixed by a split pin, other locking elements or a catch connection or the like.

To protect the sawing device, a strip 36 extending parallel to the bearer 17, or a sleeve arranged between the holding elements 16 on the bearer 17, or strip sections may be provided as a saw guard.

The device 11 is shown in a sawing position 40 in FIG. 3. After the device 11 has been loaded with meter-long logs 14, the clamping devices 41 inserted into the holding elements 16 before the loading are placed around the meter-long logs 14 in order to fix them in a bundle 47. The clamping straps 41 are preferably lashed by quick-release locks 42. After that, a first and a second saw cut 43 can be set by means of a sawing device. These saw cuts 43 are preferably set centrally relative to the free region 46 between the holding element 16. After the saw cuts 43 have been made, three bundles 47′, 47″ and 47′″ are obtained, which remain in their position within the frame 12 after the sawing. Even in this position after the sawing of the meter-long logs 14 into individual bundles 47′, 47″, 47′″, the device 11 can be taken away to another location without the individual bundles being removed from or falling out of the frame 12.

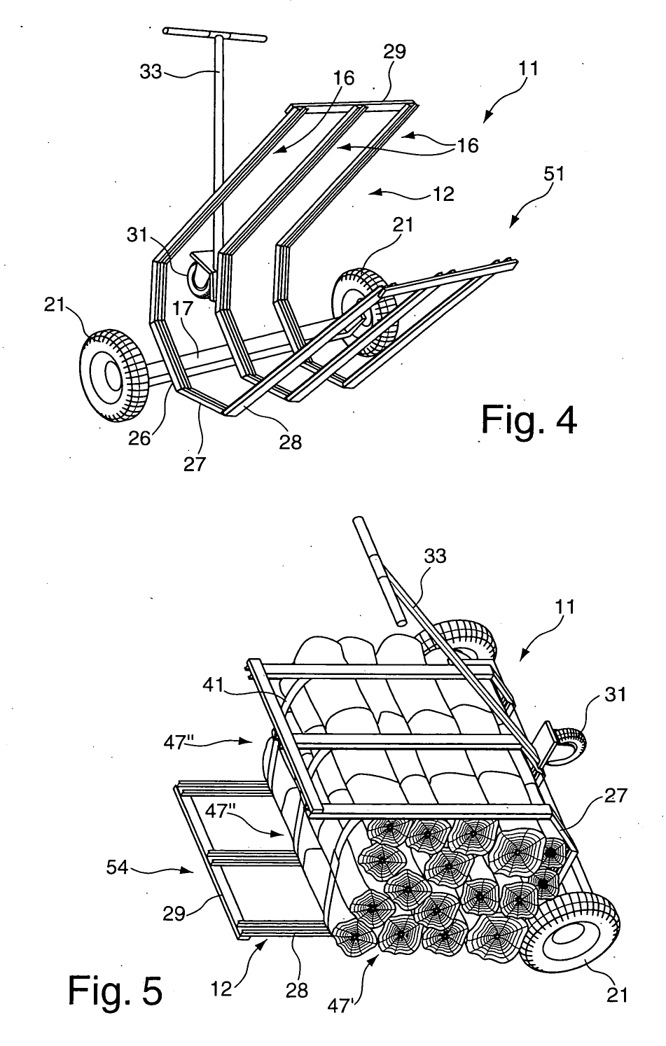

For unloading, the device 11 is shifted into an intermediate position 51, which is shown, for example, in FIG. 4. For the sake of clarity, the meter-long logs 14 are not shown. In this position, the inclined sections 27 come to rest on the ground. The travel rollers 21, likewise, preferably have contact with the ground.

The position shown in FIG. 4 may also be provided as facilitated loading position, so that shifting from the loading position 51 into the sawing position 40 is made possible after loading the device 11.

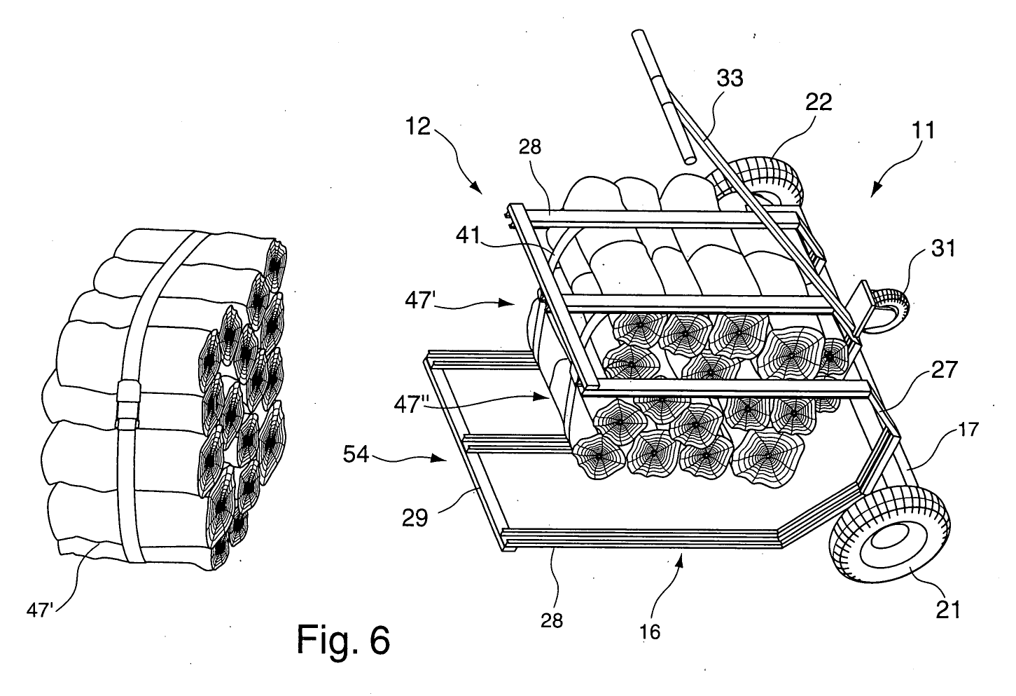

The device 11 is shown in an unloading position 54 in FIG. 5. In this position 54, the device 11 rests with the vertical sections 28 on the ground, and the travel rollers 21 are lifted. The bundles can now be removed at the front or at the side in a simple manner, as shown in FIG. 6. In this case, the clamping device 41 on the open profile cross sections of the holding elements 16 can be removed in a simple manner. The bundles 47′, 47″, 47′″ can now be opened in order to take away the individual pieces of wood, or the entire bundle 47 can be transported to the storage place by means of a transport device, such as a sack barrow for example.

The device 11 shown in FIGS. 1 to 6 can be dismantled into individual components by screwed or push-in connections, so that a small pack size is achieved in order for example to transport the device 11 over longer distances to the site in a simple manner. Metal alloys or the like may be used to form the frame 12. Rigid and light materials are preferably provided, so that the manipulation of the device 11 is facilitated. Instead of pneumatic tyres, sliding skids or the like may be interchangeably provided on the wheel axle, so that this device 11 can also be used in winter in the snow. This likewise applies to the supporting roller. As an alternative to the supporting roller, supporting elements that can also be provided in each case on the outer holding elements, instead of on the centre holding element, may also be provided.

As an alternative to the clamping straps, clamping devices that are positioned between the vertical sections 28 of a holding element 16 and act on the bearer 17 by gravitational force may also be provided, so that the individual pieces of wood are provided in a fixed position relative to one another for carrying out the saw cut. Introduced into the holding elements 16 are, for example, further elements which correspond to the contour of the holding elements and which, by a screwed connection or by clamping, interact with a top holding element and likewise perform a clamping function. In this case, too, the individual bundles 47′, 47″, 47′″ can be removed from the device in an unloading position 54.

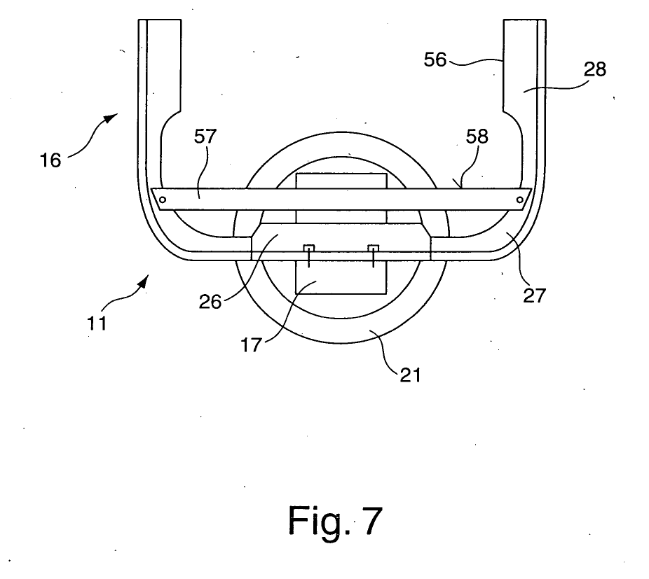

A schematic partial section of a further configuration of a device 11 according to the invention is shown in FIG. 7. This alternative device 11 according to the invention has holding elements 16 which are formed from a T-shaped profile. This T-shaped profile of the holding elements 16 and also one or more further components of the device 11 are preferably formed from an aluminium alloy or the like in order to permit a lightweight construction.

The holding elements 16 have a section 26 and a section 28, in which the T profile is formed completely. In a section 27, a leg 56 of the T profile is shortened and, if need be, is designed to be slightly notched, so that the holding element 16, preferably formed in one piece, assumes an essentially U-shaped form or can easily be converted into this shape. A cross strut 57 which is formed as flat material or preferably likewise as T-profile-shaped material is provided for stiffening the U-shaped holding element 16. At the same time, the top side 58 of the cross strut 57 can form a supporting surface. This cross strut 57 is provided at a such a height as to maintain a safety distance from the bearer 17 in order not to touch the bearer 17 after a lowermost meter-long log has been completely sawn through.

Furthermore, provision is made according to the invention for a plate, which forms a boundary of the accommodation space to be provided on an outer end face of a U-shaped holding element 16. When the pieces of wood are inserted between the U-shaped legs of the holding elements 16, the plate can serve as a stop for the inserted pieces of wood, which preferably bear with their end face against the plate.

Furthermore, provision may be advantageously made for a rope or a rod to be arranged on a top section of a vertical section 28 of the holding element 16, this rope or rod being hung or fastened on the opposite vertical section 28 of the same holding element 16. This rope or rod can serve as an indication for the filling height and can be set to different heights. At the same time, stiffening can be effected in the open region of the U-shaped holding element.

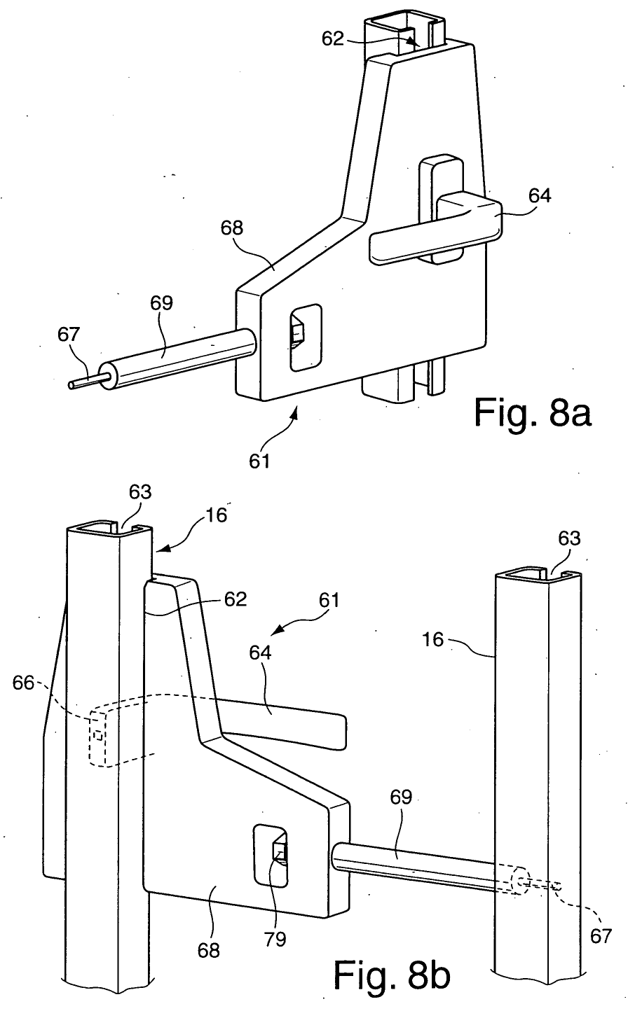

A guide element 61 according to the invention is shown in perspective in FIGS. 8a and b, this guide element 61 being designed as a receptacle and for guiding a sawing device, for example a power saw. The guide element 61 has a guide section 62, which acts on a profile of the holding element 16. The guide section 62 is designed in relation to the configuration of the holding element 16. For example, the holding element 16 is designed as a tube, square tube or U-shaped profile which has an elongated hole 63. This elongated hole 63 serves for the vertical guidance of the guide element 61 and for fixing it in a desired position. For this purpose, provision is made for a locking element 66 connected to a handle 64 to be turned by 90° and fastened.

Furthermore, the guide element 61 has a stop element 67, which bears against an adjacent holding element 16. As a result, reliable contact and rectilinear guidance along the vertical section 28 of the holding element 16, can be effected. At the same time, the cutting forces that occur can also be absorbed. The stop element 67 can be released relative to a housing 68 of the guide element 61. When a power saw is used, the stop element 67 can be inserted and passed through a hole in a guide bar of the power saw and can be fixed relative to the housing 68. The embodiment of the device shown in FIG. 7, as well as the figures described above, allow the device to be provided as a construction kit. The individual components can be connected to one another by push-in connections and screwed connections. The holding elements according to FIG. 7 can be delivered, for example, in one piece and can be converted into a U-shaped form by simple bending. A bearing spindle 69 or a guide section which is guided in the hole of the guide bar of a power saw is formed between the stop element 67 and the housing element 68. As a result, the power saw can be displaced to the left or right in a simple manner. The guide bar of the power saw is preferably brought to bear against an end face of the housing 68 in order to set the cut. This end face preferably projects towards the center of the distance between two holding elements 16. The power saw can thus be specifically guided up and down between two holding elements 16 by the guide element 61 in order to set a saw cut.

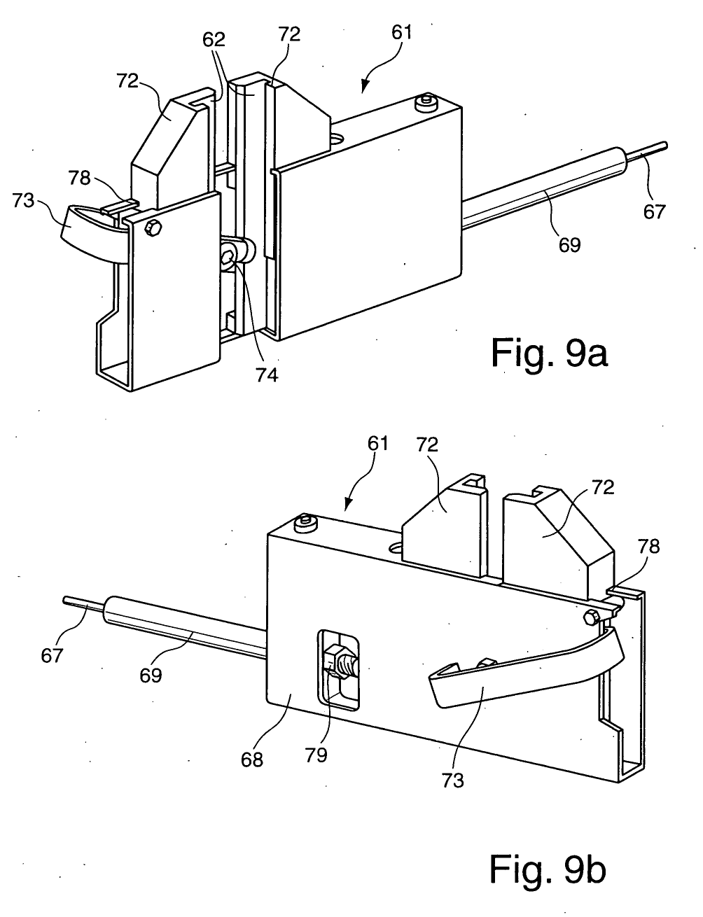

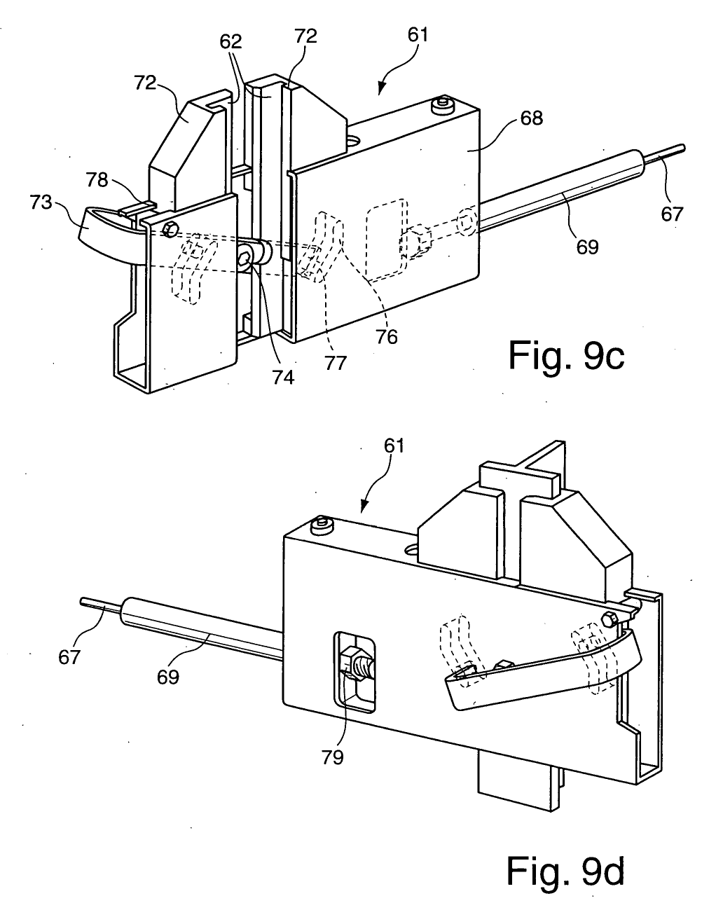

A further alternative embodiment of a guide element 61 according to the invention is shown in FIGS. 9a to d. This guide element 61 has a slotted guide section 62, which, for example, is suitable for acting on a T-shaped profile cross section, for example according to FIG. 7. The guide section 62 can also act on a C-shaped or closed profile of the holding elements 16, as shown, for example, in FIGS. 1a and b. Provided in a housing 68 are two guide jaws 72, which are moved towards and away from one another via a lever 73. The lever is preferably pivotably mounted via a pivot axis 74. This pivot axis is arranged centrally relative to the guide jaws 72, so that so a uniform opening and closing movement is achieved. For this purpose, gates 76 in which pins arranged on the lever 73 engage are provided in the guide jaws 72. The gate has a first slope, which preferably serves for a rapid closing movement. A second slope then permits the setting of a clamping position and the automatic retention in this clamping position. Due to the symmetrical configuration, effective clamping and rapid release and removal of the guide element 61 relative to the holding element 16 can be effected by a short lever displacement.

The guide elements 72 are arranged in a sheet-metal housing. The guide jaws 72 are guided in guides 78 in a longitudinally movable manner. The jaws are likewise guided in the housing interior, so that canting during the clamping operation is avoided.

The stop element 67 or the bearings 68, 69 arranged directly thereon are provided so as to be interchangeable relative to the housing 68 in each case on their own or jointly. Rapid and simple release and exchange of different stop elements or bearing spindles for accommodating sawing devices is effected by a screw fastening 79.

Furthermore, provision may be made for two guide elements 61 to be arranged adjacent to one another and for the guide elements to be connected to one another via a bearing spindle. The sawing device can be positioned and guided between the two guide elements 61.

In FIG. 9, the housing 68 is preferably designed as a sheet-metal/stamped construction, thereby allowing simple production. In FIG. 8, the housing 68 is designed, for example, as a milled part, in particular as an aluminium alloy or the like. Such a housing is preferably used in the case of holding elements which are likewise produced from aluminium alloys or the like.

Furthermore, the guide elements 61 may also have sliding rails, between which, for example, a hand saw is guided in order to set a saw cut using muscle power without motor assistance.

The features described above are in each case essential to the invention on their own or can be combined with one another in any desired manner.

What is claimed is:

1. A device for cutting pieces of wood to size, in particular meter-long logs, to form log pieces or firewood, having a frame (12) for accommodating meter-long items, which frame (12) comprises spaced-apart holding elements (16) which are designed in a U shape and between which free regions (46) for saw cuts (43) are provided, characterized in that the frame (12) can be shifted from a sawing position (40) about a pivot axis (24) into a unloading position (54).

2. The device according to claim 1, characterized in that at least one leg (28) of the U-shaped holding element (16) is designed as a supporting surface in an unloading position (54).

3. The device according to claim 1, characterized in that the pivot axis (24) lies in a framework of a chassis (1).

4. The device according to claim 1, characterized in that the pivot axis (24) of the frame (12) is arranged in a sunk position relative to a wheel axle (23), running in parallel, of a chassis (19).

5. The device according to claim 1, characterized in that the U-shaped frame (12), in the transition region between an essentially vertical section (28) and a horizontal section (26), has an inclined section (27) which, during a pivoting movement of the frame (12) from a sawing position (40) into an unloading position, comes to bear with the ground and forms an intermediate position (51).

6. The device according to claim 1, characterized in that, during the pivoting of the frame (12) from an intermediate position (51) into an unloading position, the travel rollers (21) of the chassis (19) are lifted from the ground.

7. The device according to claim 1, characterized in that the frame (12) has at least three U-shaped holding elements (16) on a bottom bearer (17).

8. The device according to claim 7, characterized in that free top ends of the US-shaped holding elements (16) are fixed relative to one another by at least one tie rod (29).

9. The device according to claim 7, characterized in that the tie rod (29) is provided so as to be pivotable or removable relative to the holding elements (16).

10. The device according to claim 1, characterized in that the holding elements (16) are profiled in a U-, T- or C-shape in cross section or are designed as a hat profile or as profiles with lateral grooves or niches.

11. The device according to claim 1, characterized in that the holding elements (16) have a closed profile which is of round or polygonal design.

12. The device according to claim 1, characterized in that each holding element (16) accommodates a clamping device (41) which, after the meter-long logs (14) have been inserted, fixes the individual pieces of wood to form a bundle.

13. The device according to claim 12, characterized in that the clamping device (41) is designed as clamping straps.

14. The device according to claim 12, characterized in that the clamping device (41), before the meter-long logs have been inserted into the frame (12), which is arranged in a sawing position (40), is inserted into the open cross section of the holding elements (16).

15. The device according to claim 1, characterized in that the U-shaped holding elements (16) are arranged on the bearer (17) in a releasable or push-in manner.

16. The device according to claim 1, characterized in that individual sections (26, 27 and 28) of the holding elements (16) are designed in a releasable or push-in manner relative to one another.

17. The device according to claim 1, characterized in that the pivot axis (24) is designed as bearer (17) which accommodates a travel roller (21) at a left-hand and a right-hand end in a push-in manner.

18. The device according to claim 1, characterized in that a support or a supporting roller (31) is provided on a holding element (16).

19. The device according to claim 1, characterized in that a shaft (33) or a handle is provided on a holding element (16).

20. The device according to claim 19, characterized in that a support or a support roller (31) or a shaft (33) or a handle is provided on a centre holding element (16) of the frame (12).

21. The device according to claim 20, characterized in that the shaft (33) is arranged in a push-in manner.

22. The device according to claim 1, characterized in that a common pivot point (32) of the meter-long logs (14) which are accommodated by the frame (12) lies outside the pivot axis (24) of the frame and is preferably arranged in a sunk position relative to the pivot axis (24).

23. The device according to claim 22, characterized in that an asymmetrical arrangement of the horizontal section (26) of the holding element (16) relative to the bearer (17) is provided, the offset being provided towards the side on which the support or the supporting roller (31) is provided on the holding element (16).

24. The device according to claim 1, characterized in that a saw guard (36) is provided on the bearer (17) or the holding elements (16).

25. The device according to claim 24, characterized in that the saw guard (36) being designed as a wooden or plastic strip or as sleeves arranged between the holding elements (16) on the bearer (17).

25. The device according to claim 24, characterized in that the saw guard (36) being designed as a wooden or plastic strip or as sleeves arranged between the holding elements (16) on the bearer (17).

26. The device according to claim 1, characterized in that guide elements for a saw cut (43) are inserted or are arranged between the U-shaped holding elements (16).

27. The device according to claim 1, characterized in that the holding elements (16) on a front side have a vertical section (28) which is shorter than the rear section (28).

28. The device according to claim 1, characterized in that a hand-guided power saw is used for cutting meter-long items.
